(19) United States
(12) Patent Application Publication
(10) Pub. No.: US 2019/0005740 A1
(43) Pub. Date: Jan. 3, 2019

(54) SYSTEM AND METHOD FOR MANAGING A PARKING PROCESS OF A VEHICLE IN A PARKING ZONE WHICH IS SUBJECT TO CHARGES, AND FOR MANAGING A COUNTING PROCESS FOR PAYING PARKING CHARGES

(71) Applicant: Sunhill Technologies GMBH, Erlangen (DE)

(72) Inventor: Matthias MANDELKOW, Bubenreuth (DE)

(73) Assignee: Sunhill Technologies GMBH, Erlangen (DE)

(21) Appl. No.: 15/526,169

(22) PCT Filed: Nov. 10, 2015
(86) PCT No.: PCT/EP2015/002250

§ 371 Date: Aug. 14, 2017

(30) Foreign Application Priority Data
Nov. 11, 2014 (DE) 10 2014 016 559.0

(51) Int. Cl. G07B 15/04; G06Q 20/32

(52) U.S. Cl. CPC G07B 15/04; G06Q 20/327

(57) ABSTRACT

According to the invention, the system comprises—control means for controlling the parking process and the counting process, preferably a control device which is connected to a communications network in order to transmit signals, first means for identifying the user and/or the vehicle which means has a communication connection to the control device, second means of identifying the entry process, which means has a communication connection to the control device and/or to the device for identifying the user, third means for implementing the identification, which means has a communication connection to the control device, wherein the third identifying means is embodied in such a way that it detects the identification of the entry process for triggering and/or carrying out a counting, process, fourth means which is embodied and has a communication connection to the control device and/or to the other means such that said other means bring about a release, wherein the control means is designed to generate an exit permission signal, in response to the transfer of the identification signals from a user to the control device, and wherein the control means is embodied in such a way that it triggers the counting process an; or carries it out as soon as the parking zone is exiled. The system is operated correctly with the associated method.

A system and a method for managing a vehicle parking operation in a parking zone subject to fees and a payment process for paying parking fees.

The present invention relates to a system for managing a vehicle parking operation in a parking zone subject to fees and for managing as a payment process for paying parking fees. The invention furthermore relates to a corresponding method for operating the system according to the invention Managing the parking operation is understood to mean the parking subject to fees in private and public parking spaces and/or barrier-controlled parking structures, which includes automatic payment transactions. Automatic payment transactions are defined as determining the parking fee following a specified parking period, the debiting of the determined parking fee from an account of the vehicle user, and the release of the vehicle once the debiting from the account is complete.

Methods and systems are known from the prior art which support a predetermined parking in free parking zones, in individually localizable parking areas. Different approaches are used for this. In most cases, wireless signal transmission and, in particular, mobile radio transmission are used.

Specifically, a parking fee system is known from the WO 96/27170 A (Parkit Oy) which comprises a control unit with parking fee register that permits assigning a parking space to the vehicle of a user and which determines the fees based on stored data for parking fees, as well as the associated information relating to the parking period, which is called up from a user account.

A parking fee system is furthermore proposed in the WO 01/88 855 A (—EP 1 312 049 B1 (Payway Oy)), for which a parking fee center is activated by a parking ticket machine and which is connected via mobile telephone network to the user. Upon leaving the parking zone, an exit control device is activated via the parking fee center, using a ticket-specific exit permission code.

In the WO 01/88 856 A(=EP 1312 050 B1 (Payway Oy)), on the other hand, it is proposed that individual parking spaces be defined for the parking operation and that the information for these parking spaces be additionally recorded in the register of the parking fee center to determine the correct parking fees.

The unique feature of the aforementioned systems is—according to the older prior art—that the payment function must always be realized prior to leaving the parking zone. To be sure, cell phones and mobile radio systems are already used therein. However, the release and, if applicable, the opening of the barrier only takes place when the payment process is completed. For the user, this results in a waiting period in front of the barrier.

Organizing the identification process with the aid of suitable means in such a way as to simplify the management of the parking operation and the associated payment process for paying the parking fees has already been proposed in the older, not previously published International Patent Application PCT/EP2014/00215 (sunhill technologies GmbH, WuPa January 2014).

Starting therefrom, it is the object of the present invention to further improve the system proposed in the aforementioned patent application, as well as the associated method for operating the system.

This object is solved according to the invention by the total number of features listed in patent claim 1. Modifications relating to different aspects of the invention are the subject matter of the dependent device claims 2 to 19. To realize this system, a sequence of method steps is carried out as defined in patent claim 18 and/or patent claims 19 to 21.

It is essential for the invention that beacon devices are used for the technical means which communicate with the control unit. The use of beacons (“beacon lights”) as signal transmitters is known. The name iBeacon is a registered trademark of the company Apple Inc. Apart from that, the name has become established as a generic term in the technical field. The beacon devices derived therefrom, in short the iBeacons, are proximity detection systems and are viewed in modern technology as a new class of cost-effective transmitters which require little energy and can detect the presence of so-called IOS7 systems. Smartphone IOS7 operating systems, in particular, can thus be activated by the iBeacons to perform actions. However, they can also be used with Android and/or Windows operating systems for Smartphones.

Through the combined use of iBeacons for the entrance-barrier region or the exit barrier region and a suitable APP in the smartphone, the start and the end of the parking period can now be detected precisely. Using suitable, software-controlled logic units, it is possible to identify vehicles and users and/or Smartphones.

To be sure, the use of standard Bluetooth technology for transmitting signals between a mobile phone and a control unit is known for activating the barriers at the entrance and/or the exit of parking zones provided with barriers. For this, we point in particular to the US2003/0224 766 A1 (Skidata=EP 1 353 298 A1), the US2003/0 050 793 A1 and the US2004/0 012 481 A1. The individual barriers of the parking zones are activated therein via cell phone and SMS, once the registration and payment process are resolved. However, iBeacons are not specifically used for this.

As previously mentioned, the use of specifically the beacon technology has been known for some time. Not known or suggesting itself, however, is its use for parking systems where specifically the iBeacons can execute different functions. Considerable economic advantages are obtained, in particular, when specifically combining iBeacons in parking systems with the registration of the user, as well as the detecting and managing of the parking fees.

For the realization of the invention, we can proceed on the assumption of a parking zone with traditional barrier. However, the inventive solution of using beacons for solving the problem can advantageously also be used for parking zones without barriers and on inner-city streets with separate parking lanes.

As an alternative to the presently used “parking ticket” with identifier, the invention respectively provides for a different identification option to be allocated, in short called a Vticket, wherein according to the invention the iBeacons and a suitable Smartphone APP are used. These communicate via Bluetooth, in particular Bluetooth Low Energy (BLE), which requires little energy.

For the purpose of the invention, so-called “digital” parking tickets are therefore used. A physical parking ticket is needed only in case of a malfunction while, otherwise, the process is handled exclusively via the above-mentioned media. As a result, virtual barriers can also be realized.

The parking duration and the amount to be paid are computed by the operator of the parking structure only after leaving the parking zone, that is the parking structure. The system for managing a vehicle parking operation in a parking zone subject to fees and a process for paying parking fees subsequently debits this amount from the corresponding account of the user and notifies the user, e.g. via SMS.

If the parking fee cannot be paid via cell phone as a result of the service being temporarily unavailable, or if an exit signal cannot be generated, for example because of insufficient funds in the account, the parking space user is still liable for paying the fees. In that case, alternative payment options can be used, such as the cash register.

On the whole, it must be noted that the user generally does no longer receive and must keep a paper ticket. Consequently, there is no risk of the paper ticket being lost and that a corresponding “fine” must be paid, meaning a fee defined for such a case. In addition, the paper ticket use is reduced for the parking space administrator.

As previously mentioned, for the first time the invention can now also be used for for parking spaces without barriers. For this, one or several iBeacons are assigned to the parking zone at a suitable position, wherein the iBeacons are connected contactless to the Smartphone and/or an associated APP in the Smartphone. APPs of this type can in the future advantageously be integrated into the digital information system of a vehicle.

Further details and advantages of the invention follow from the description below of an exemplary embodiment in connection with the individual patent claims.

Shown are in

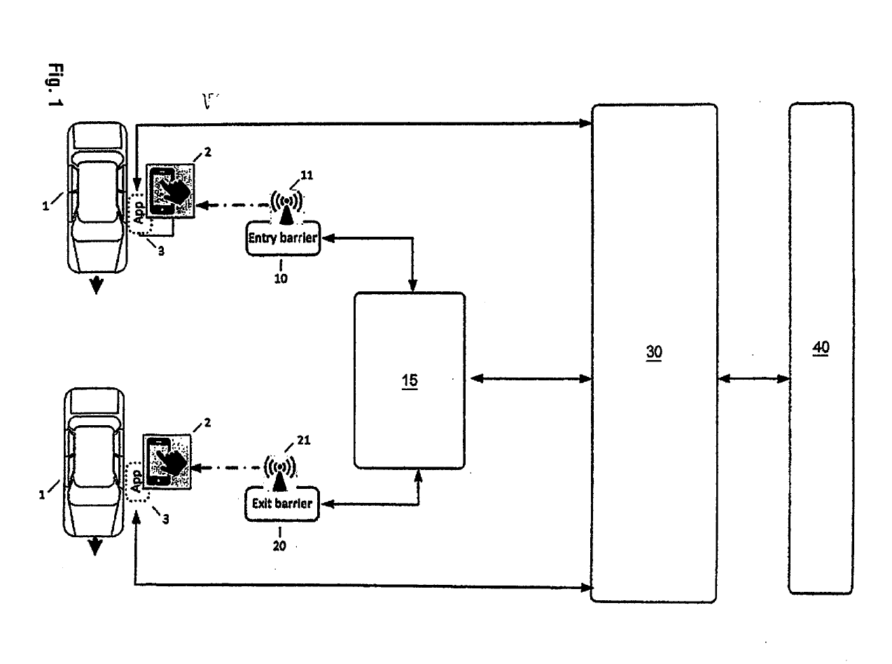

FIG. 1 a diagram for the use of iBeacons in a parking space and/or a parking structure using barriers, having entrance and/or exit blocking devices;

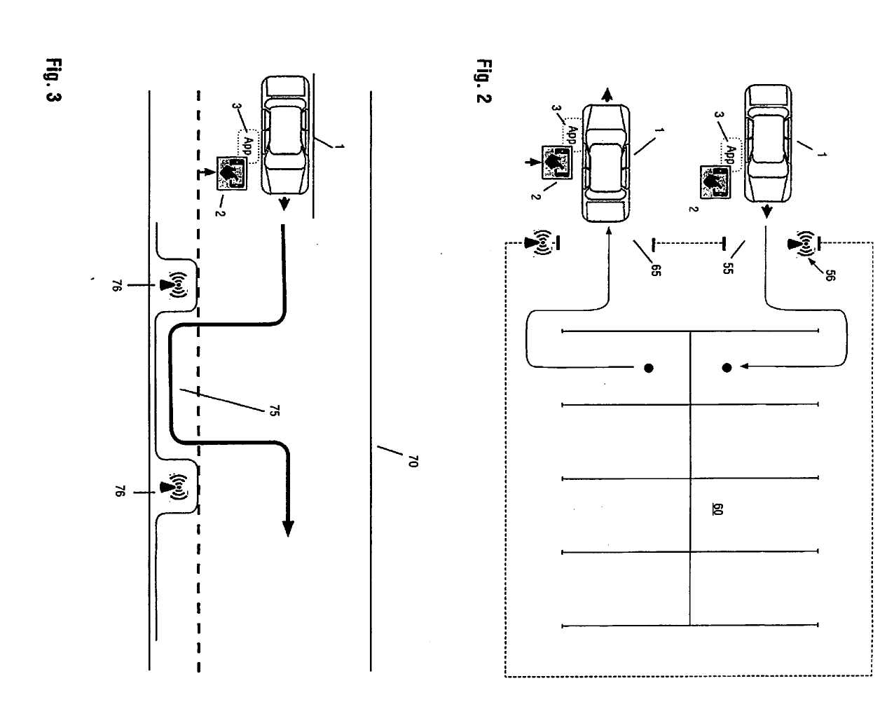

FIG. 2 the use of iBeacons for a parking space and/or a parking structure without entrance and/or exit blocking devices;

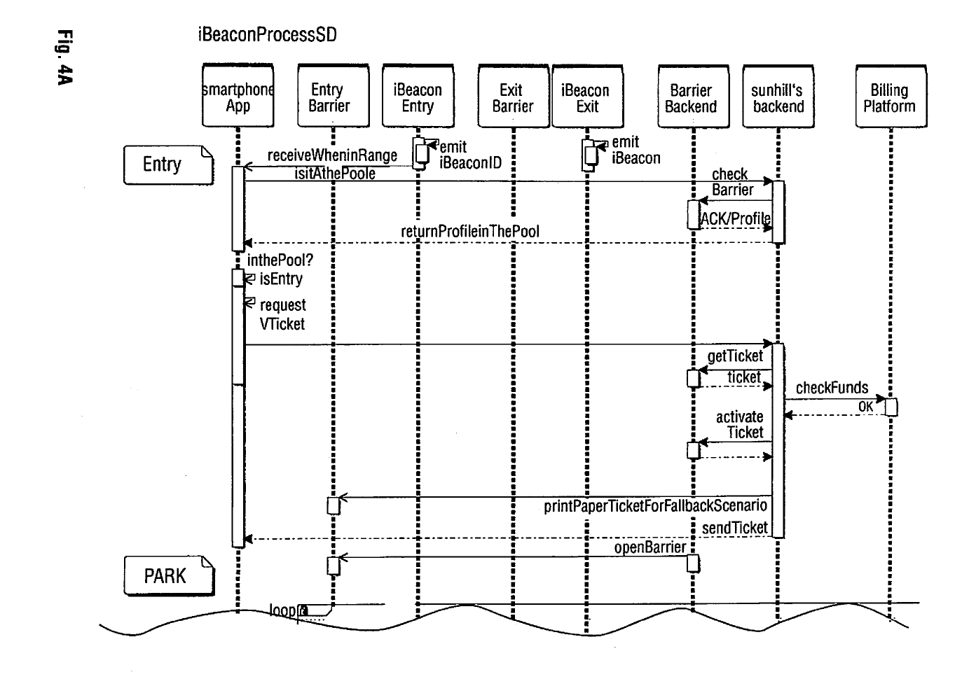

FIG. 3 the system with iBeacons for street parking; and

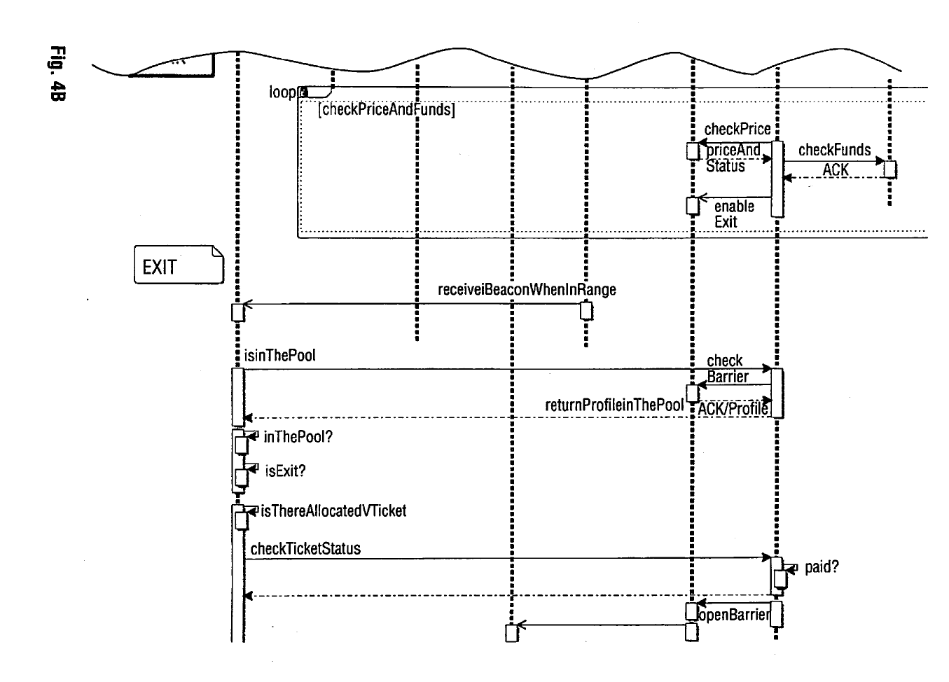

FIG. 4 a sequence diagram with a timely adaptation of the signals in the complete functional sequence.

In FIGS. 1 to 3, the number 1 respectively denotes a vehicle and/or the associated user of the parking system, located in a parking zone that is not characterized in detail herein, such as a parking structure, a parking space or also a street with parking lane. The user of the vehicle 1 has a Smartphone 2 which contains a specific application program 3 (so-called APP). An APP of this type is available commercially, for example under the tradename of Travipay (registered trademark of the company sunhill technologies GmbH).

An entrance barrier 10 and an exit barrier 20 are shown specifically in FIG. 1. The entrance barrier 10 is assigned an iBeacon 11 and the exit barrier 20 is assigned an iBeacon 21. The entrance barrier 10 and the exit barrier 20 are connected to a barrier-control system 15, which has a communication link to a logic unit 30. For safety reasons, the supplier of the system (e.g. sunhill technologies GmbH) can communicate only via the logic unit 30 with the barrier-control system 15.

The logic unit 30 comprises an APP logic, a transaction logic, a garage business-transaction logic, and a calculation logic which are not described in detail at this time, but are embodied as software. Also provided is a unit 40 as the accounting platform, which is used for generating bills and serves as the communication link with the logic unit 30.

The logic units described in this way are integrated into the system for managing the parking operation and computing the parking fees according to the older patent application PCT/EP2014/00215. The following constraints apply when using it for a parking operation:

A precondition is that the user in the vehicle 1 has available an iBeacon-activated cell phone 2 which is generally the case with newer Smartphones. If a Smartphone application (APP 3) is installed in this device, the systems of the parking garage and/or the parking zone with barriers can be activated with the iBeacon.

Once the vehicle 1 and/or the user with the cell phone 2 enters the transmission range of the iBeacon 11, the identity is received in the APP3 and transmitted further to the processing unit 30. For this, the iBeacon identity is read by the APP and is checked in the logic unit 30 with the aid of a system-specific pool. Insofar as the iBeacon is not stored therein, it is ignored. However, if it belongs to the stored pool, a barrier profile is sent to the APP. The APP then checks whether the barrier profile belongs to the entrance barrier 10.

The user receives a message asking whether he/she would like to receive a digital ticket. The user can confirm that he/she would like a digital (virtual) ticket (Vticket). For this, the vehicle must be parked with the engine turned off. Alternatively, the user can also indicate in the settings that the digital ticket is to be generated automatically, without manual confirmation. The user is then given a reference to the StVO if he/she wants to confirm.

The Vticket request is transmitted to the logic unit 30. The logic unit 30 then requests that the barrier-control system 15 generate a new, specific Vticket. The barrier-control system 15 generates a new Vticket and sends it to the logic unit 30. The logic unit 30 then sends the Vticket to the APP3.

In case of an error or malfunction, meaning if the cell phone does not work, for example because of battery exhaustion or the like, a paper ticket can be printed if necessary. The logic unit 30 activates the Vticket and sends it to the barrier-control system 15. The entrance barrier system opens the barrier 10 and the user can park the vehicle 1.

During the parking, either a one-time or a periodic accounting process is realized. In the first case, the payment amount is debited upon exiting the parking structure. In the second case, the amount respectively due for the parking is debited or allocated at specific time intervals. Following each debiting/allocating, the ticket status is renewed and the parking time is automatically renewed. If a problem occurs, in particular if the amount in the prepaid account is used up, the ticket is deleted and the user must pay the unpaid amount in the conventional way, using a paper ticket at a cash payment machine.

The reverse operation takes place when leaving the garage as for entering the garage. The user drives the vehicle 1 to the exit barrier 20. The iBeacon 21 at the exist barrier 20 identifies itself to the APP3 of the user's Smartphone 2. The APP3 sends the iBeacon identity 11 to the logic unit 30, which checks the identity of the iBeacon 11 and ignores it if it is not part of the pool.

The APP receives the barrier profile and checks whether this profile belongs to the exit barrier 20. The APP checks whether a digital Vticket was generated and also checks whether the payment amount makes sense and whether the amount has been paid, meaning debited. The APP 3 transmits via the logic unit 30 a signal for opening the exit barrier 20. The exit barrier 20 opens and the user can exit with the vehicle 1.

If a problem occurs with the iBeacon 21 or the cell phone 2 of the user (e.g. battery empty), the user can, if necessary, insert the paper ticket obtained at the entrance barrier 10 at the exit barrier 20. The ticket is then checked and the exit barrier 20 is raised once the amount is paid.

The number 50 in FIG. 2 relates to a free parking zone with marked parking spaces 60, as well as an entrance 55 and an exit 65. An iBeacon 56 is assigned to the entrance 55 and an iBeacon 66 is assigned to the exit 65. Several entrance and exit options can exist to which respectively one iBeacon is assigned. However, it is advantageous if two iBeacons are provided, which is sufficient.

The number 70 in FIG. 3 refers to a street with parking lane 75 on the side, on which at least one street parking space is realized. An iBeacon (pair) 76 is assigned to a street parking space of the parking lane 75.

The latter thus provides the advantageous option of realizing a corresponding signal detection with paperless billing, for example for the parking zones of inner city parking locations.

FIG. 4 shows a so-called sequence diagram for the exemplary embodiment according to FIG. 1. The vertical line here illustrates the time sequence and the horizontal line illustrates the individual stations for the management and timely billing of the parking operation. The position “Entry” stands for the entering, the position “Park” for the parking period, and the position “Exit” for the exiting. The individual stations are the smartphone APP, the entrance barrier, the beacon entrance, the exit barrier, the beacon exit, the barrier end position, the operator plane, and the accounting platform corresponding to FIG. 1. The term backend in this case is understood to refer to the activity of the service provider. The connecting arrows illustrate the course of the activities which conforms to the operation of the system.

FIG. 4 illustrates the sequence of steps during the parking with automatic identification and a timely accounting. The method is realized with the following steps:

Entering:

1. The user has an iBeacon activated cell phone

2. The user drives into an iBeacon activated garage.

3. In the operator area, the APP checks the iBeacon identity

4. The APP reads the backend identity and compares it to the operator pool

5. If the iBeacon does not belong to the operator pool, it is ignored

6. In the operator area, the APP backend checks the Beacon identity, provided it belongs to the operator

7. The APP checks the operator backend to see if the iBeacon cooperates with the entrance barrier

8. The APP detects the notification

9. The user confirms that he/she would like to receive a digital ticket (so-called Vticket)

10. The request for a Vticket is forwarded to the operator backend

11. The operator backend communicates to the barrier backend the request for a ticket for the specific entrance

12. The barrier backend forwards a ticket to the operator backend

13. The operator backend delivers a Vticket

14. The operator backend activates the Vticket

15. The barrier system opens the entrance barrier

Parking:

16. The user parks

17. The operator backend runs the accounting process in the background, either periodically debiting the user account or in agreement with the line of credit for the user.

Exiting:

18. The user drives to the exit barrier

19. Within the scanning range of the iBeacon at the exit barrier, it identifies itself to the existing APP service of the user Smartphone

20. The APP checks the Beacon identity and suppresses the notification if it is not part of the operator pool

21. The APP is sent the Beacon profile and checks whether it corresponds to the exit barrier

22. The APP checks whether an active Vticket exists

23. The operator backend instructs the barrier backend to open the barrier

24. The barrier opens and the user drives out

25. In case of an error or malfunction, a paper ticket is generated which can be paid in the conventional manner.

For FIG. 2 and FIG. 3, that is when the invention is realized without barriers, a corresponding sequence diagram results, but without the stations for the entrance/exit barriers.

In conclusion, it must be noted that with the system described with the aid of FIGS. 1 to 4, the iBeacons respectively function to detect the parking period and, following the verification of the user in the logic unit, also function to trigger actions such as the opening of barriers corresponding to FIG. 1, but can also be used to connect to the specific operator APP and to detect the identity of the user. In any case, the individual parking period utilized by the user can thus be determined and the account settled.

For parking zones without barriers—as indicated in FIGS. 2 and 3—the iBeacons serve exclusively to determine the start and the end of the parking period subject to fees. This is achieved via a modified signal course, corresponding to the sequence diagram shown in FIG. 4. Essential in this case are again the advantageous characteristics of the system, such as:

a) The user pays the parking fee via his/her Smartphone with APP; there is no need to wait in front of a ticket booth.

b) The payment is made directly via the payment platform, either with a credit card or through direct debiting from an account (SEPA debiting).

c) The user can at any time activate a ticket via his/her Smartphone with APP, not necessarily when exiting the parking garage. This results in flexibility and overpayments for unpaid parking periods are avoided.

d) The activated ticket is paid automatically upon leaving the parking zone.

### REFERENCE NUMBER LIST

FIG. 1/FIG. 2/FIG. 3

1 vehicle/user

2 cell phone (Smartphone)

3 Smartphone APP

FIG. 1

10 entrance blocking device

11 iBeacon

15 logic control unit

20 exit blocking device

21 iBeacon

30 logic unit

40 payment processing platform

FIG. 2

50 parking zone

60 marked parking spaces

55 entrance

56 iBeacon

65 exit

66 iBeacon

FIG. 3

70 street

75 parking lane

76 iBeacon

FIG. 4 Sequence Diagram

ENTRY entering

PARK parking

EXIT exiting

Smartphone APP application program

Entry Barrier barrier at the entrance

iBeacon Entry iBeacon entrance

Exit barrier barrier at the exit

iBeacon exit iBeacon at the exit

Barrier Backend barrier control

sunhills Backend operator platform

Billing Platform accounting or billing platform

1. A system for managing a vehicle parking operation in a parking zone subject to fees and a payment process for paying parking fees, comprising
a control unit for controlling the parking operation and the payment process, wherein the control unit is connected to a communication network for transmitting signals;
first means for identifying the user and/or the vehicle, which means are connected so as to communicate with the control unit;
second means for identifying the process of entering the parking zone, which means are connected so as to communicate with the control unit and/or the means for identifying the user;
third means for detecting the time of the vehicle entrance, which means are connected so as to communicate with the control unit, wherein the third means are embodied to detect the identifier for the entrance of the vehicle in order to trigger and/or realize a payment process;
fourth means which are embodied in such a way and are connected so as to communicate with the control unit and/or the other means that they trigger a release for the exit of the vehicle;
and wherein the control unit is embodied to receive and process the identification signals via the communication network;
wherein the control unit is embodied for generating an exit permission signal in response to the user transmitting the identification signals to the control unit;
and wherein the control unit is embodied such that it triggers and/or processes the payment process as soon as the vehicle leaves the parking zone;
characterized by the use of beacon devices (11, 21; 56, 66, 76) for localizing the cell phone (2) of the user of the vehicle (1) and for activating the process of precisely and in a timely manner detecting the entrance and/or exit of the vehicle (1).

2. The system according to claim 1, characterized in that a Bluetooth Low Energy (BLE) technology is used for the beacon devices.

3. The system according to claim 1, characterized in that the beacon devices comprise so-called iBeacons (11, 21; 56, 66, 76).

4. The system according to claim 1, characterized in that respectively one barrier (10, 20) is present at the entrance and the exit of the parking zone (FIG. 1).

5. The system according to claim 1, wherein it is possible to drive without stopping through the entrance and the exit, and wherein no barriers which must be clearly delimited exist at the entrance and exit of the parking zone, characterized in that respectively one iBeacon (56) is assigned to the entrance (55) and one iBeacon (66) to the exit (65) (FIG. 2).

6. The system according to claim 1, wherein no clearly delimited entrance and exit exist, characterized in that at least one iBeacon (76) is assigned to the parking area (75) with at least one parking space (FIG. 3).

7. The system according to claim 1, characterized in that the signal processing and the selection of the iBeacon signals are controlled by Software (FIG. 4).

8. The system according to claim 1, characterized in that means are provided for processing the iBeacon signals.

9. The system according to claim 1, characterized in that a so-called Vticket (“virtual ticket”) can be generated.

10. The system according to claim 1, characterized in that the cell phone of the user is a Smartphone (2) is provided with an application program (APP 3) that is suitable for detecting iBeacons (11, 21).

11. The system according to claim 1, characterized in that at least one iBeacon (11, 21) is provided in each entrance and each exit region of the parking zone.

12. The system according to claim 1, wherein barriers (10, 20) are provided in the entrance and exit region, characterized in that the iBeacons (11, 21) are assigned to the barriers (10, 20) and control these barriers.

13. The system according to claim 12, characterized in that the iBeacons are connected so as to communicate with a control unit (15).

14. The system according to claim 13, characterized in that the control device is a control unit (15) for monitoring and controlling the barriers (10, 20).

15. The system according to claim 1, characterized in that logic units are provided for the APP on the cell phone, for operating the optional barriers, for managing the parking spaces, and for the billing process.

16. The system according to claim 1, characterized in that the logic units are components of a management-related computer unit (30), comprising the APP logic, the activation logic, the parking space management logic and the billing logic, which is connected so as to communicate with the control unit (15).

17. The system according to claim 1, characterized in that a user platform (40) is provided for the billing, which is connected so as to communicate with the computer unit (30).

18. A method for managing a parking operation for a vehicle in a parking zone subject to fees and a payment process for paying parking fees, comprising a control unit for controlling the parking operation and the payment process, wherein the control unit is connected to a communication network, wherein this method involves the following steps:
generating information upon request from a user;
generating and issuing a user-specific identification;
releasing a user-specific access;
recording/reading in the information and the user-specific identification with answer-code;
wherein the control unit receives the answer-code via the communication network;
wherein the control unit generates an exit permission signal in response to a user transmitting the answer-code to the control unit;
wherein the control unit triggers and/or realizes the payment process as soon as the exit signal is generated, or was generated, and
wherein beacon devices (11, 21; 56, 66, 76) are used for detecting the parking time.

19. The method according to claim 20, for which a parking zone with barriers exits,
wherein virtual parking tickets are generated
and wherein Smartphones with specific application programs (APPs) suitable for iBeacons are used.

20. The method according to claim 18, characterized in that the parking operation is controlled by the beacon signal.

21. (canceled)
